(19) United States
(12) Patent Application Publication
(10) Pub. No.: US 2013/0310019 A1
(43) Pub. Date: Nov. 21, 2013

(54) CELL RANGE EXTENSION FOR COOPERATIVE MULTIPOINT

(71) Applicants: Eugene VISOTSKY, Buffalo Grove, IL (US); Bishwarup Mondal, Schaumburg, IL (US)

(72) Inventors: Eugene VISOTSKY, Buffalo Grove, IL (US); Bishwarup Mondal, Schaumburg, IL (US)

(73) Assignee: Nokia Siemens Networks Oy

(21) Appl. No.: 13/472,887

(22) Filed: May 16, 2012

(51) Int. Cl. H04W 24/00

(52) U.S. Cl. 455/422.1

(57) ABSTRACT

A user equipment UE takes measurements of at least a first and a second transmission point. The UE applies a bias value in favor of the second transmission point to at least one of the measurements, and thereafter utilizes the measurements after the bias value is applied to select a set of transmission points to recommend for cooperative multipoint CoMP transmissions. In more specific examples: the first and second transmission points are respective macro and micro/pico cells, and the UE further measures channel state information CSI from each transmission point of the selected CoMP set and reports that without applying the bias value to any of them. The examples show this approach works even if the cells share a common physical cell ID PCID.

### TECHNICAL FIELD

The exemplary and non-limiting embodiments of this invention relate generally to wireless communication systems, methods, devices and computer programs and, more specifically relate to cell range extension for wireless cooperative multipoint communications.

### BACKGROUND

Coordinated multi-point (CoMP) transmission is currently being investigated in 3GPP (third generation partnership project). CoMP entails multiple distinct transmission points to jointly transmit or transmit from a single point but in coordination with others data to a receiving device, and one motivation for downlink (DL) CoMP is to allow fast coordination among the different transmission points to improve throughput performance. For example, the CoMP transmission points for a given user equipment (UE) might be a macro cell and a micro/pico cell in the E-UTRAN (evolved universal terrestrial access network) system of which two different implementations are shown in FIGS. 1A-B. The micro/pico cells may each be served by a remote radio head controlled by the eNB in one example deployment. Another example is multiple eNBs (macro E-UTRAN access nodes or base stations).

To enable closed-loop transmission from multiple transmission points to a given UE, channel state information (CSI) for multiple radio links needs to be measured by the UE and sent to the network, and in E-UTRAN these measurements are sent on the logical physical uplink control channel (PUCCH) or the physical uplink shared channel (PUSCH). The UE can measure CSI from common reference signals (CRS) which are sent in the DL for that purpose. DL control transmissions in the E-UTRAN system are sent to the UE on a physical downlink control channel (PDCCH) and DL data transmissions are sent to the UE on a physical downlink shared channel (PDSCH). A group of co-located antennas form a transmission point. For CoMP transmissions, the joint DL transmission to the UE may be from multiple transmission points. Some of the transmission points may be geographically separate.

It is known that biasing traffic load towards the micro/pico and away from the macro significantly improves performance in a heterogeneous network (HetNet) radio environment. A micro/pico is assumed to transmit with much less total power than a macro. FIG. 1A illustrates two instances of such HetNet deployments known in 3GPP as CoMP scenario 4, in which the same physical cell identifier (PCID) is shared by the macro eNB and by the pico nodes within the coverage of the macro. CoMP scenario 3 is shown at FIG. 1B and is characterized by each distinct node (and thus each potential CoMP transmission point) in the HetNet having a different PCID.

In CoMP scenario 4, biasing traffic within a cell using the conventional (legacy) handover protocol does not appear possible, because all transmission points within a cell are indistinguishable from one another based on legacy CRS measurements by the UE. Thus it does not appear possible to bias traffic in CoMP scenario 4 (FIG. 1A), or in a mixed PCID assignment scenario (mixed scenarios 3 and 4) in which some but not all transmission points of a given HetNet utilize the same PCID.

Currently in 3GPP RAN1 specifications, for measurements based on CRS/CSI-RS, a ratio of the CRS/CSI-RS EPRE energy per resource element (EPRE) to PDSCH EPRE can be indicated to a UE. It is possible to include a bias value as part of the EPRE ratio. But this EPRE ratio is used at the UE for subsequent CSI feedback calculations (for example: precoding matrix index PMI; channel quality indication CQI; rank indicator RI). It is not desirable to include a bias value in the EPRE ratio for biasing the selection of transmission points as it would result in the CSI feedback giving a biased view of the radio link conditions being experienced by the UE, from which would follow the network choosing erroneous link adaptation settings for the UE. Hence, there is a need for new signaling method in the 3GPP specification to enable traffic biasing/load-balancing. Note that the 3GPP and E-UTRAN context are specific examples for better explaining the problem which these teachings can resolve, but those contexts are not limiting to the broader teachings and principles which are presented in detail below.

### SUMMARY

In the following, for ease of understanding different aspects of the invention are described with respect to two kinds of eNBs—a macro with higher power and a micro/pica with lower power. In general, however, all aspects of the invention are equally applicable to any eNBs or transmission points.

According to a first exemplary aspect the invention there is a method comprising: taking measurements at a user equipment of at least a first and a second transmission point; applying a bias value in favor of the second transmission point to at least one of the measurements, and thereafter utilizing the measurements after the bias value is applied to select a set of transmission points to recommend for cooperative multipoint transmissions.

According to a second exemplary aspect the invention there is an apparatus comprising: at least one processor and at least one memory including computer program code. In this aspect the at least one memory and the computer program code are configured, with the at least one processor and in response to execution of the computer program code, to cause the apparatus to perform at least: taking measurements of at least a first and a second transmission point; applying a bias value in favor of the second transmission point to at least one of the measurements, and thereafter utilizing the measurements after the bias value is applied to select a set of transmission points to recommend for cooperative multipoint transmissions.

According to a third exemplary aspect the invention there is a computer readable memory storing a program of instructions which when executed by at least one processor result in actions comprising: taking measurements of at least a first and a second transmission point; applying a bias value in favor of the second transmission point to at least one of the measurements, and thereafter utilizing the measurements after the bias value is applied to select a set of transmission points to recommend for cooperative multipoint transmissions.

These and other aspects are detailed further below.

### BRIEF DESCRIPTION OF THE DRAWINGS

FIG. 1A is a prior art schematic diagram illustrating a HetNet radio environment in which the transmission points of a given HetNet utilize the same PCID, known in the 3GPP as CoMP scenario 4.

FIG. 1B is a prior art schematic diagram similar to FIG. 1A but illustrating a HetNet radio environment in which the transmission points of a given HetNet utilize different PCIDs, known in the 3GPP as CoMP scenario 3.

FIG. 2 is a signaling diagram illustrating various messages that are exchanged and certain process steps, and also reflect a method, and a result of execution by one or more processors of a set of computer program instructions embodied on a computer readable memory, in accordance with the exemplary embodiments of this invention.

FIG. 3 is a simplified block diagram of a UE and macro and micro/pico eNB which are exemplary electronic devices suitable for use in practicing the exemplary embodiments of the invention.

### DETAILED DESCRIPTION

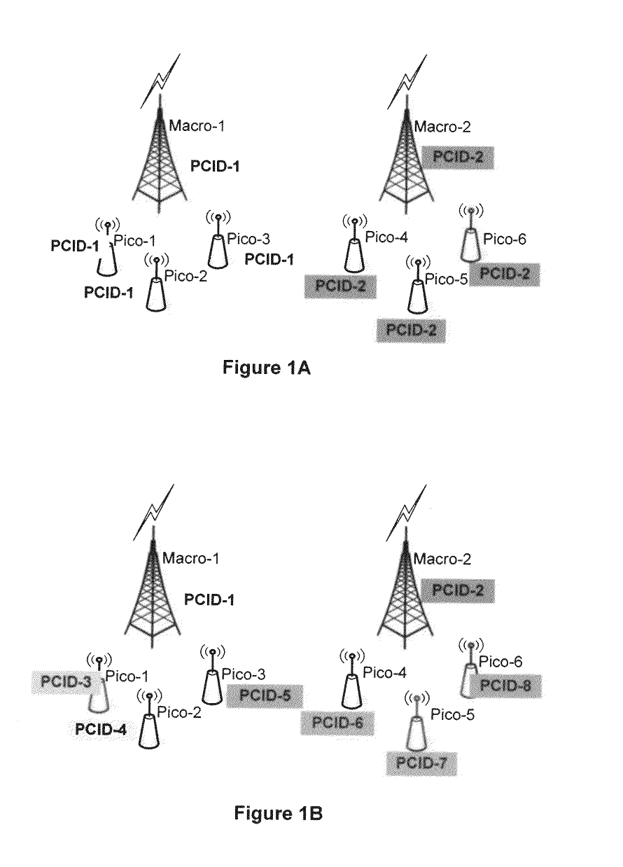

As noted above there is a performance improvement if HetNet traffic could be biased towards the micro/pico network. The non-limiting examples below detail a technique to do just that, and are particularly useful for the CoMP scenario 4 shown at FIG. 1A, as well as for HetNets with mixed scenarios 3 and 4 where some but not all cells share a common PCID.

First let us detail an example radio environment for the below non-limiting examples. There is a HetNet PCID scenario 4 as shown in FIG. 1A in which the macro and micro/pico eNBs that are deployed within proximity of each other and also share the same PCID. One or more micro/pico nodes may be utilized by extending their range (by biasing), in what is termed cell range extension (CRE). The macro and micro/pico cells are used for CoMP transmissions to an UE. In the E-UTRAN system CRE is a load-balancing technique whereby UEs are forced to attach to a micro/pico eNB by means of handover signaling and a judicious choice of the handover threshold or through implementation specific methods in scenario 4.

Embodiments of these teachings enable CRE or load-balancing within a footprint of a distributed antenna system. Such embodiments may be implemented by adapting CoMP algorithms that are used in Het Net deployments. In this manner significant performance gains may be attained in PCID scenario 4 by biasing the CoMP traffic load towards micro/pico eNBs and utilizing CoMP techniques at the same time. These techniques can also be used where some but not all cells share a common PCID [e.g., a hybrid of PCID scenario 3 (FIG. 1B) and scenario 4 (FIG. 1A)], as well as HetNet deployments where each eNB is assigned a unique PCID (scenario 3).

In these more general deployments these teachings enable traffic to be biased towards a particular set of transmission points without reconfiguring the CoMP measurement set for a UE. This is a ‘soft’ biasing meaning that it favors a particular set of nodes to be selected less often, as opposed to a ‘hard’ bias which wholly eliminates certain nodes from the CoMP measurement set based on their PCID assignments.

The more difficult case is that when the macro eNB and the micro/pico eNB share the same PCID and so appear indistinguishable to the UE with respect to conventional/legacy handover measurements which are based on common reference signals (CRS). Embodiments of these teachings bias the load balancing in favor of, for example, the micro/pico eNB over the macro eNB for the CoMP transmission point set that the UE recommends to the macro eNB.

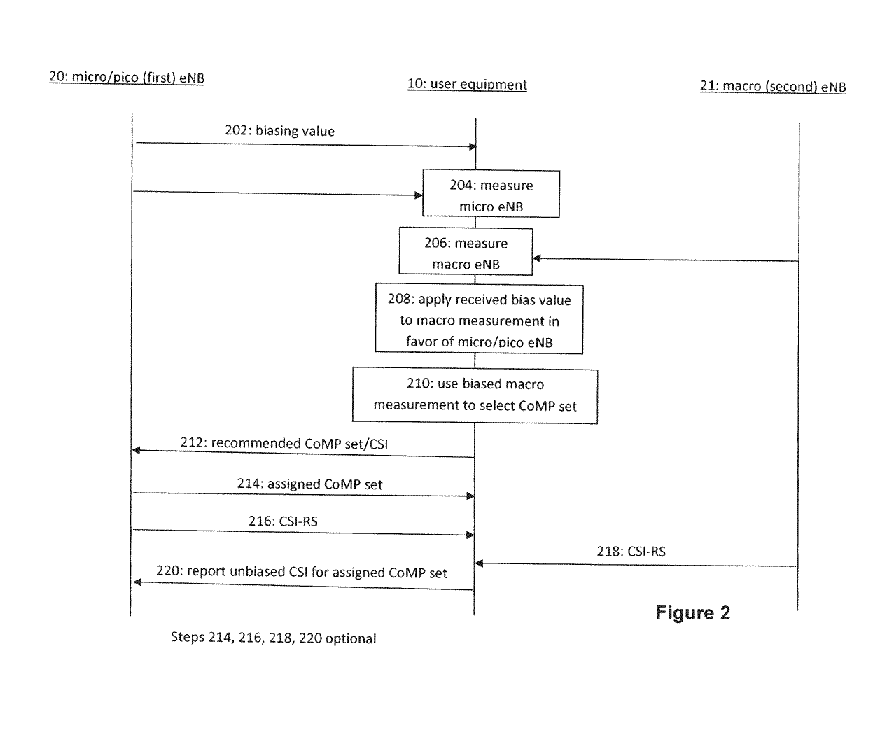

The principles of these teachings are more clearly described with reference to the signaling diagram of FIG. 2, which also shows internal processes of the UE 10 and of the eNB 20 which in this example is a micro/pico eNB or more generally a first eNB 20 to which the UE 10 is attached. FIG. 2 illustrates only one macro eNB 21 (more generally the second eNB 21) but in practice there may be more than only one micro/pico or macro eNBs which might be candidates for the UE's recommended CoMP set. It is assumed that CSI-RS or CRS are transmitted from the first eNB 20 and second eNB 21 that can be identified and measured by the UE 10. It is assumed that the UE 10 is attached to the first/micro eNB 20 and receives interference from the second/macro eNB 21. At message 202 the micro/pico eNB 20 signals to the UE 10 a biasing value which the UE will apply as will be described. In order to set up a joint CoMP transmission first the UE must measure and report on the cells it can receive, so at 204 the UE measures a signal it receives from the first/micro eNB 20 and at 206 the UE 10 measures a signal it receives from the second/macro eNB 21. By example these signals may be CSI reference signals, which the UE can use to distinguish the different transmission points 20, 21 even if they both use the same PCID.

At block 208 the UE applies the supplied biasing value to the measurement it took on second/macro eNB 21. In this specific but non-limiting FIG. 2 example the biasing value is a negative bias on the second eNB 21 so as to bias traffic toward the first/micro/pico eNB 20. For example, the UE 10 may measure the power that it receives from eNB 21 and reduce that power by the biasing value. In another example the UE 10 may increase the value of a threshold that is applied to the measurements from eNB 21. Or equivalently the biasing value might be a positive bias, and applied to increase the measured power received from the micro/first eNB 20 or to increase the value of the threshold it applies for that micro/first eNB 20. However implemented, in this example, the bias value is applied so as to favor one or more of the potential low-power (micro/pico eNB) CoMP transmission points, regardless of which transmission point to which the UE is currently attached. In general, a bias could be applied to any transmission point. The network knows where it would like to bias the traffic different from what is the current UE attachment and the CoMP set and so sets the biasing value accordingly. If the UE 10 is performing measurements from multiple eNBs it may apply the same bias value to the measurements from one more micro/pico eNBs or to the thresholds applied to one or more micro/pica eNBs. Then at 210 the UE selects a CoMP transmission point set based on the received signals, with those of the eNB(s) 21 biased according to the received value.

In another exemplary embodiment the UE 10 receives multiple bias values from the first eNB 20 (to which it is attached) and applies different bias values to measurements from different transmission points or to thresholds corresponding to different transmission points. An example of selecting a CoMP transmission point set could be comparing the power measured from multiple transmission points to a common threshold and selecting the transmission points that are above the threshold. The bias value may be applied to one or more transmission points before the comparison. Instead of power, examples of other criteria for comparison could be throughput or spectral efficiency (for example, signal to noise ratio SINR). In another example a UE may be required to report only the top 2 or n transmission points according to the criterion (and after the bias is applied, n being a positive integer). Note that the bias may be equivalently applied to the threshold instead of the measurements.

At message 212 the UE 10 sends to the first eNB 20 its recommended CoMP transmission point set that it selected at 210. The UE 10 may also send channel state information (CSI) in message 212. As an example, the UE 10 may send precoding matrix index (PMI), channel quality information (CQI), and rank indicator (RI) of the best transmission point in message 212. It may be noted that the bias is applied to derive the best transmission point but once the transmission point is determined the PMI, CQI and RI are derived from measurements without the application of the bias. It may be noted that the recommended CoMP transmission point set may have only one member. As an example, it may be the best transmission point.

The steps 214, 216, 218 and 220 as described below in accordance with FIG. 2 may be optional.

In message 214 the first eNB 20 sends the UE its assigned CoMP transmission point set which may or may not be identical to the UE's recommended set, depending on network considerations for CoMP joint transmissions to this UE 10. Not shown but assumed at FIG. 2, then the transmission points of the assigned CoMP set may begin CoMP transmissions to the UE 10.

At regular intervals or when specifically tasked by the first eNB 20 (to which the UE is attached), the UE 10 then takes measurements of the transmission points in the assigned CoMP transmission set. As above, the UE 10 can distinguish these different transmission points based on their respective reference signal, even if they have the same PCID. When reporting these measurements the UE's CSI feedback is not biased, so as to provide accurate information for the macro eNB's scheduling and link adaptation computations and procedures.

The signaling diagram of FIG. 2 is also valid for joint transmission (JT) CoMP as noted in the above example, and also for dynamic point selection (DPS) CoMP where the UE 10 may report only one node/transmission point for its dynamically recommended set. In one embodiment the biasing value is signaled as 202 in broadcast system information, but this may also be communicated using dedicated signaling where the first eNB 20 decides a per-UE biasing value to better maximize throughout of the CoMP transmissions for that particular UE 10.

The above embodiments are summarized and assembled at FIG. 2 is also a logic flow diagram that illustrates the operation of a method, and a result of execution of computer program instructions, in accordance with the exemplary embodiments of this invention. The various steps and messages shown in FIG. 2 may be viewed as method steps, and/or as operations that result from operation of computer program code embodied on a memory and executed by a processor, and/or as a plurality of coupled logic circuit elements constructed to carry out the associated function(s).

One technical effect of the above embodiments is that CSI-RS or CRS measurements from individual transmission points within a CoMP cluster set are used to determine the per-UE CoMP subset to be activated for transmitting DL data to that UE. Applying the above bias to the measurements enables the traffic load to be shifted towards the micro eNB network through the biased CoMP subset selection. Bias values to be applied can be configured and signaled to the UEs as a broadcast message or on a per-UE basis. In CoMP scenario 3 where each transmission point has a unique PCID, a bias value may be similarly applied to the common reference signal (CRS−) based or to the CSI RS-based measurements taken by the UE.

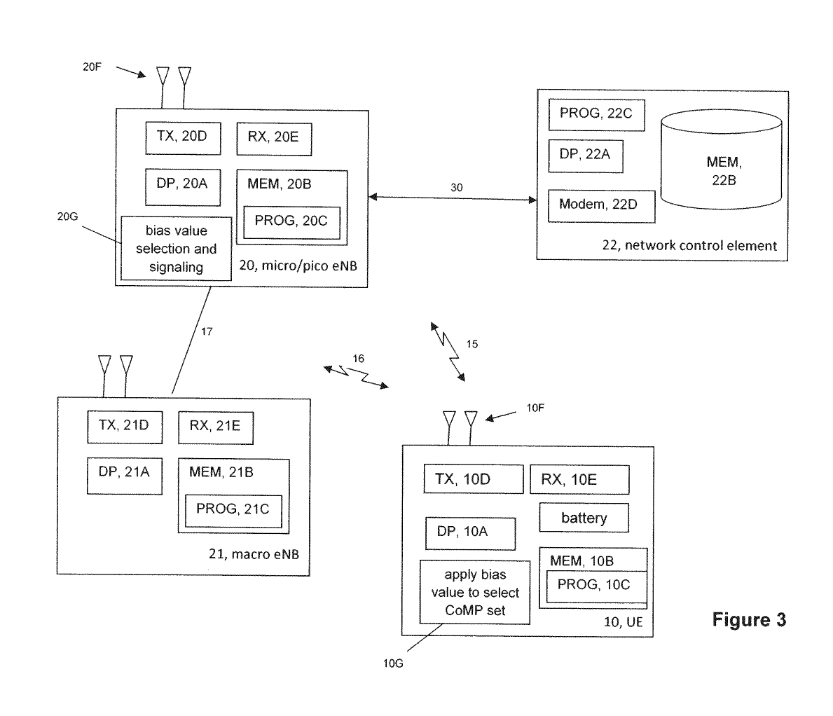

Reference is made to FIG. 3 for illustrating a simplified block diagram of various electronic devices and apparatus that are suitable for use in practicing the exemplary embodiments of this invention. In FIG. 3 a wireless network is adapted for communication over a wireless link 15 and a wireless link 16 with an apparatus, such as a mobile communication device which above is referred to as a UE 10, via a network access node such as a Node B (base station), and more specifically a eNB 20 and a eNB 21. The network may include a network control element (NCE) 22 that may include mobility management entity/serving gateway MME/S-GW functionality that is specified for LTE/LTE-A. The NCE 22 also provides connectivity with a different network, such as a publicly switched telephone network and/or a data communications network (e.g., the Internet). While only one wireless link 15, 16 is shown for each transmission point 20, 21, each representing multiple logical and physical channels, it is understood there may be multiple logical and physical channels between the UE and each transmission point.

The UE 10 includes a controller, such as a computer or a data processor (DP) 10A, a computer-readable memory medium embodied as a memory (MEM) 10B that stores a program of computer instructions (PROG) 10C, and a suitable radio frequency (RF) transmitter and receiver 10D for bidirectional wireless communications with the eNBs 20, 21 via one or more antennas (two shown). The UE 10 may have one or more than one radios 10D for communicating with the eNBs 20, 21.

The eNB 20 also includes a controller, such as a computer or a data processor (DP) 20A, a computer-readable memory medium embodied as a memory (MEM) 20B that stores a program of computer instructions (PROG) 20C, and suitable RF transmitters and receivers (two shown as 20D) for communication with the UE 10 via one or more antennas (also two shown). The eNB 20 is coupled via a data/control path 30 to the NCE 22. The path 30 may be implemented as the S1 interface known in the E-UTRAN system. The eNB 20 may also be coupled to the eNB 21 via data/control path 17, which may be implemented as the X2 interface known in the E-UTRAN system.

For completeness, the eNB 21 is also shown to include a c data processor (DP) 21A, a computer-readable memory medium embodied as a memory (MEM) 21B that stores a program of computer instructions (PROG) 21C, and suitable RF transmitters and receivers for communication with the UE 10 via one or more antennas (two shown). The NCE 22 also has a DP 22A, a MEM 22B storing a PROG 22C and a modem 22D for communicating over the data/control link 30 with the eNB.

At least one of the PROGs 10C and 20C is assumed to include program instructions that, when executed by the associated DP, enable the device to operate in accordance with the exemplary embodiments of this invention, as detailed above. That is, the exemplary embodiments of this invention may be implemented at least in part by computer software executable by the DP 10A of the UE 10 and/or by the DP 20A of the macro eNB 20, or by hardware, or by a combination of software and hardware (and firmware).

For the purposes of describing the exemplary embodiments of this invention the eNB 20 may be assumed to also include a program or algorithm to cause the eNB 20 to determine and to signal the bias value to the UE as shown at 20G. Further the UE 10 includes a program or algorithm to cause the UE 10 to apply the bias value it receives from the macro eNB to the cell measurements it takes and to use that biased measurement to select its CoMP recommended transmission point set as shown at 10G, according to the non-limiting examples presented above.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 10B and 20B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A and 20A may be of any type suitable to the local technical environment, and may include one or more of general purpose computers, special purpose computers, microprocessors, digital signal processors (DSPs) and processors based on a multicore processor architecture, as non-limiting examples.

In general, the various exemplary embodiments may be implemented in hardware or special purpose circuits, software, logic or any combination thereof. For example, some aspects may be implemented in hardware, while other aspects may be implemented in embodied firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, embodied software and/or firmware, special purpose circuits or logic, general purpose hardware or controller or other computing devices, or some combination thereof, where general purpose elements may be made special purpose by embodied executable software.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

While the exemplary embodiments have been described above in the context of the E-UTRAN system, it should be appreciated that the exemplary embodiments of this invention are not limited for use with only this one particular type of wireless communication system that uses carrier aggregation with cross-scheduling.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method comprising:
taking measurements at a user equipment of at least a first and a second transmission point;
applying a bias value in favor of the second transmission point to at least one of the measurements; and thereafter
utilizing the measurements after the bias value is applied to select a set of transmission points to recommend for cooperative multipoint transmissions.

2. The method according to claim 1, in which the first transmission point is a macro cell and the second transmission point is a micro cell or a pico cell.

3. The method according to claim 2, in which the method is executed by the user equipment and the bias value is received in dedicated signaling.

4. The method according to claim 1 in which the measurements are taken on channel state information reference signals, and the first and the second transmission points share a common physical dell identity.

5. The method according to claim 1, in which the measurements are taken on common reference signals.

6. The method according to claim 1 further comprising measuring channel state information from each transmission point of the selected set and reporting the measured channel state information without applying the bias value to any of the measured channel state information.

7. The method according to claim 6, where reporting the measured channel state information comprises reporting precoding matrix index (PMI), channel quality information (CQI), and rank indicator (RI).

8. An apparatus comprising:
at least one processor; and
at least one memory including computer program code,
in which the at least one memory and the computer program code are configured, with the at least one processor and in response to execution of the computer program code, to cause the apparatus to perform at least:
taking measurements of at least a first and a second transmission point;
applying a bias value in favor of the second transmission point to at least one of the measurements; and thereafter
utilizing the measurements after the bias value is applied to select a set of transmission points to recommend for cooperative multipoint transmissions.

9. The apparatus according to claim 8, in which the first transmission point is a macro cell and the second transmission point is a micro cell or a pico cell.

10. The apparatus according to claim 9, in which the apparatus comprises a user equipment and the bias value is received in dedicated signaling.

11. The apparatus according to claim 8 in which the measurements are taken on channel state information reference signals, and the first and the second transmission points share a common physical dell identity.

12. The apparatus according to claim 8, in which the measurements are taken on common reference signals.

13. The apparatus according to claim 8 in which the at least one memory and the computer program code are further configured to cause the apparatus to perform:
measuring channel state information from each transmission point of the selected set and reporting the measured channel state information without applying the bias value to any of the measured channel state information.

14. The apparatus according to claim 13, where reporting the measured channel state information comprises reporting precoding matrix index (PMI), channel quality information (CQI), and rank indicator (RI).

15. A computer readable memory storing a program of instructions which when executed by at least one processor result in actions comprising:
taking measurements of at least a first and a second transmission point;
applying a bias value in favor of the second transmission point to at least one of the measurements; and thereafter
utilizing the measurements after the bias value is applied to select a set of transmission points to recommend for cooperative multipoint transmissions.

16. The computer readable memory according to claim 15, in which the first transmission point is a macro cell and the second transmission point is a micro cell or a pico cell.

17. The computer readable memory according to claim 16, in which the computer readable memory and the at least one processor are disposed within a user equipment and the bias value is received in dedicated signaling.

18. The computer readable memory according to claim 15 in which the measurements are taken on channel state information reference signals, and the first and second transmission points share a common physical dell identity.

19. The computer readable memory according to claim 15 in which the actions further comprise:
measuring channel state information from each transmission point of the selected set and reporting the measured channel state information without applying the bias value to any of the measured channel state information.

20. The computer readable memory according to claim 19, where reporting the measured channel state information comprises reporting precoding matrix index (PMI), channel quality information (CQI), and rank indicator (RI).
